(19) United States
(12) Patent Application Publication
(10) Pub. No.: US 2010/0159185 A1
(43) Pub. Date: Jun. 24, 2010

(54) APPLYING A DESIGN ON A TEXTILE

(75) Inventors: Celine M. Cremin, Mallow (IE); Padraig M. Moloney, Kinsale (IE)

Correspondence Address: Levenfeld Pearlstein, LLC (ILLINOIS TOOL WORKS), 2 North LaSalle Street, Suite 1300, Chicago, IL, 60602, US

(73) Assignee: ILLINOIS TOOL WORKS INC., Glenview, IL (US)

(21) Appl. No.: 12/644,725

(22) Filed: Dec. 22, 2009

Related U.S. Application Data
(60) Provisional application No. 61/143,992, filed on Jan. 12, 2009.

(30) Foreign Application Priority Data
Dec. 22, 2008 (IE) 20081016

(51) Int. Cl. B05D 1/16; B32B 5/30

(52) U.S. Cl. 428/90; 156/72

(57) ABSTRACT

An appliqué for applying a design to a fabric includes a flock in a pre-determined multi-colour pattern retained by a flock adhesive and an application adhesive suitable for adhering the appliqué to a fabric. A garment or piece of fabric having an appliqué and a method of decorating a fabric by applying an appliqué using an application adhesive are disclosed.

### BACKGROUND OF THE INVENTION

The invention relates to application of designs to textiles.

GB2245220 describes a multi-layer transfer sheet, in which granules are fixed to a permanent adhesive layer on flock fibres. To apply the design to a textile, the granule layer is placed against the textile surface and heat and pressure are applied. The granules melt and seep into the fabric to fix the design, and a disposable peel-off sheet is peeled away. GB2245220 involves a large number of processing steps, which include multiple drying and screen printing operations. With this process there are potentially issues of coverage over certain colours and durability on certain types of fabric.

Accordingly, there is a need for improved application of designs to textiles, in terms of versatility in the colour of designs, and/or ease of application, and/or durability, and/or resistance to dye migration into the textile. Such an improved application also reduces manufacturing operations and provides an ability to use any of a variety of raw materials such as: woven textiles, hot-melt films, and/or flocking adhesive. Other objectives are to achieve greater flexibility, durability and/or resistance to dye migration.

### BRIEF SUMMARY OF THE INVENTION

An appliqué for applying a design to a fabric includes a flock in a pre-determined multi-colour pattern retained by a flock adhesive and an application adhesive suitable for adhering the appliqué to a fabric.

In one embodiment, the flock adhesive is deposited on a substrate such as a film or a fabric. In one embodiment, the substrate has multiple colours, viewable in-between the flock. In one embodiment, the substrate is of polyurethane material. Alternately, the substrate is of fabric material. The fabric material can be sublimated with a pre-printed pattern. The fabric can be of woven fibre, such as a high-lustre type. The fibre can be a satin or satin-like material. The fibre can be polyester.

The substrate can be a foil material. The foil can include a holographic pattern. The substrate can include a migration-resistant barrier.

The application adhesive can be a hot-melt. A garment or piece of fabric can be provided with the appliqué as described above.

A method of decorating a garment or piece of fabric includes applying the appliqué as described above to the fabric using the application adhesive.

For purposes of the present disclosure, the term “appliqué” means a decorative patch or badge which is applied to a fabric to impart a decorative design such as a logo on the fabric such as a garment.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a cross-sectional view of an appliqué of the invention for application of a design to a garment;

FIG. 2 shows the appliqué after application onto textile fabric; and

FIGS. 3 to 7 are cross-section views of alternative appliqués of the invention.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

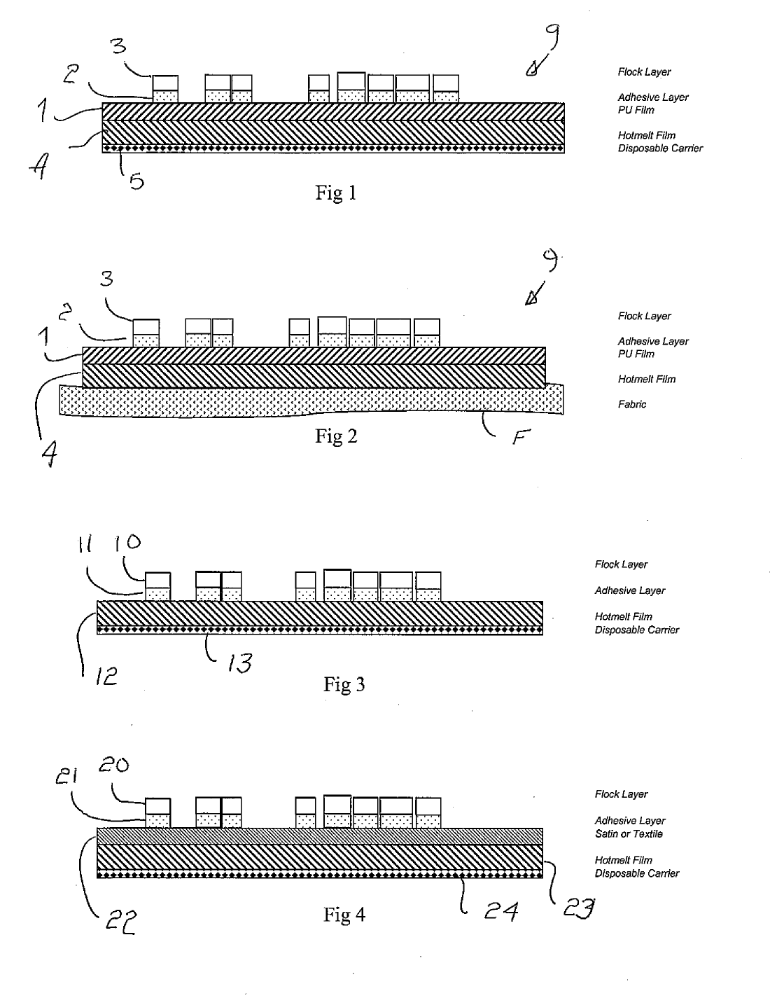

Referring to FIGS. 1 and 2, an appliqué 9 in accordance with the principle of the present invention includes a polyurethane (“PU”) film 1 onto which a flock adhesive, namely a permanent adhesive layer 2, is printed. As set forth above, for purposes of the present disclosure, the term “appliqué” means a decorative patch or badge which is applied to a fabric to impart a decorative design such as a logo on the fabric such as a garment.

A flock fibre layer 3 is applied onto the adhesive layer 2 using an electrostatic field. The flock layer 3 can be multi-coloured, in which case, each colour is applied sequentially using a conventional flocking method. An application adhesive, namely a hot-melt layer 4, is laminated to the PU film 1 prior to or after the flocking operations.

The hot-melt adhesive comprises a thermoplastic film made from aromatic or aliphatic thermoplastic. The hot-melt film can include one or more of, but is not limited to, polyamide; polyester; polyolefin; polyurethane; and polyurethane ester. For example, the hot-melt film can be 76 micron Bemis Polyester Hotmelt Film 5250.

To apply a design to a textile, including, for example (but not limited to a satin or satin-like material), the appliqué 9 is simply placed on the textile after removing the disposable carrier 5, with the hotmelt film 4 in contact with the textile. Heat and pressure are applied so the hot-melt impregnates into the fabric (F) to seal the appliqué in place. Alternatively, application can be carried out using a high frequency welding method.

The invention has a major advantage of not requiring deposition of any material onto the flock—thus preserving clarity of colour and edge definition of the design. Also, it is very simple to apply, and high-frequency welding or heat and pressure may be used. The invention has the major advantage that the flock fibres are not deposited into a release adhesive which at application will tend to pull out quantities of flock fibres resulting in incomplete flock coverage. The invention makes use of a non-toxic permanent hot-melt adhesive. The cross-linking of the adhesive is one-step and permanent, not requiring additional curing time during application onto the textile. The use of textile films or hot-melt adhesive films also improves the coverage and opacity. Replacing the traditional screen-printing process of the application adhesive (which can be inconsistent in quality) by using films also substantially reduces the risk of waste material.

Referring to FIG. 3, in another embodiment, a multi-colour flock 10 is retained by permanent adhesive 11, which is deposited directly onto hot-melt 12 supplied on a carrier 13. This is a simpler arrangement, avoiding need for a PU or other film substrate. Need for a film is avoided, which allows creation of a very lightweight and potentially very elastic appliqué. In this embodiment, there is little risk of underlying colours being visible. Referring to FIG. 3, in another embodiment, a multi-color flock 10 is retained by permanent adhesive 11, which is deposited directly onto an opaque hot-melt 12 supplied on a carrier 13. In this embodiment, there is little risk of underlying colors being visible.

Referring to FIG. 4, a multi-colour flock 20 is retained by permanent adhesive 21, which is deposited on a textile 22. Again, there is hot-melt 23 and a carrier 24. This has the advantages of creating a multi-textured and three dimensional appliqué, the surface of which includes high pile flock fibres and textile satin materials of various textures.

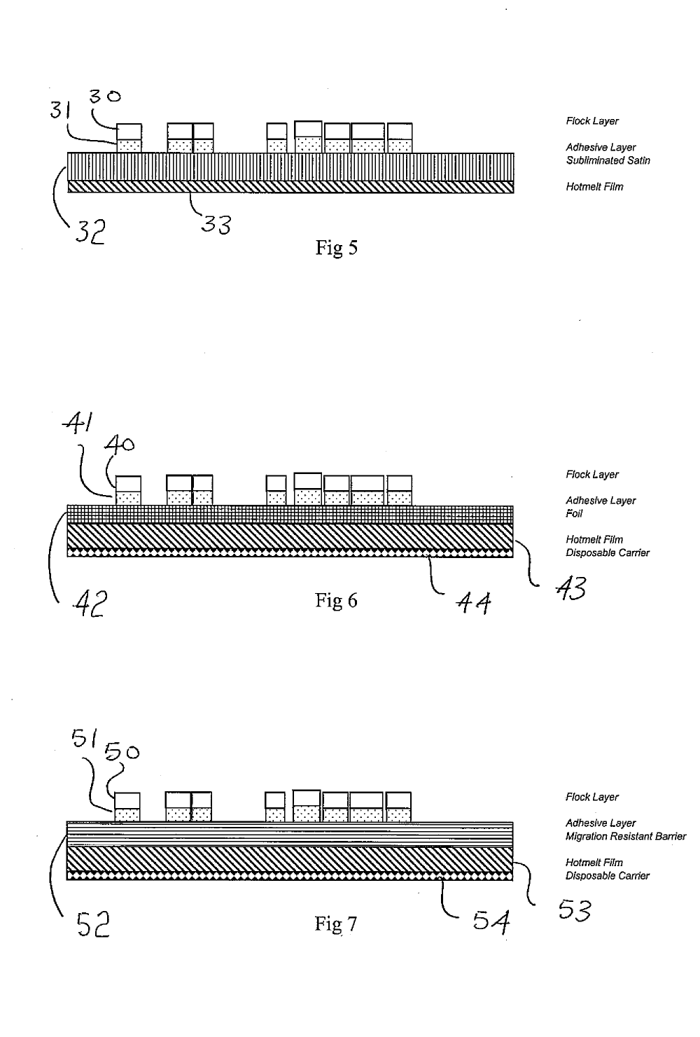

Referring to FIG. 5, in another embodiment, a multi-colour flock 30 is retained by permanent adhesive 31 onto a textile 32 which has been sublimation printed before flocking. The sublimation textile satin material used can be for example of the type supplied by the Company Houlaisha Co. Ltd. in Japan under the name NXSS. This material is disclosed in European patent application EP1876288.

Referring to FIG. 6, a multi-colour flock 40 is retained by adhesive 41 deposited on foil 42, which can be a metallic or reflective or holographic foil. Again, there is hot-melt 43 and a disposable carrier 44. This embodiment of the invention has the advantage of creating multi-textured and three-dimensional appliqués into which an element of security, brand protection and authentication can be built in.

Referring to FIG. 7, in another embodiment, a multi-colour flock 50 is retained by adhesive 51, which is deposited on a migration-resistant barrier 52, which can be a single layer or composite migration resistant barrier or membrane layer over hot-melt 53 and a disposable carrier 54 (optional). This embodiment can be used specifically where a high degree of migration/bleed through resistance is required.

The flock adhesives 2, 11, 21, 31, 41, and 51 referred to above are all of the cross-linking water-based acrylic emulsion type, the particular cross-linking for each adhesive being chosen to suit the substrate. While alternatives are possible such as a polyurethane-based adhesive for the adhesive 2 (on PU film), it is believed that water-based acrylic emulsions are more effective and are safer.

The following are examples of the adhesives which can be used in some embodiments.

Adhesive 2 (on PU film 1): Product: TUBVINYL TTH-ZP WEISS, Chemical Description: Acrylate dispersion containing titanium dioxide.

Adhesive 11 (on hot-melt 12): Product: TUBVINYL TTH-ZP WEISS, Chemical Description: Acrylate dispersion containing titanium dioxide.

Adhesive 21 (on textile 22): Product: TUBITRANS BOND-3, Chemical Description: Acrylic Co-Polymer in aqueous dispersion.

Adhesive 31 (on sublimated satin 32): Product: TUBITRANS BOND-3, Chemical Description: Acrylic Co-Polymer in aqueous dispersion.

Adhesive 41 (on foil 42): Product: TUBVINYL TTH-ZP WEISS, Chemical Description: Acrylate dispersion containing titanium dioxide.

Adhesive 51 (on migration-resistant barrier substrate 52): Product: TUBVINYL TTH-ZP WEISS, Chemical Description: Acrylate dispersion containing titanium dioxide. The above adhesives are available from CHT R. BEITLICH GMBH, Werk Oyten, Rudolf-Diesel-StraBe 19-21 28876 Oyten, Germany.

It will be appreciated that the present invention achieves improved application of designs to textiles, including, for example, satin and satin-like materials, in terms of versatility in the colour of designs, and/or ease of application, and/or durability, and/or resistance to dye migration into the textile. The present invention also facilitated reduced manufacturing operations and improves the ability to use any of a variety of raw materials such as woven textiles, hot-melt films, and/or flocking adhesive. This promotes greater flexibility, durability and/or resistance to dye migration.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. An appliqué for applying a design to a fabric, the appliqué comprising:
a flock in a pre-determined multi-colour pattern retained by a flock adhesive; and
an application adhesive suitable for adhering the appliqué to a fabric.

2. The appliqué in accordance with claim 1, wherein the flock adhesive is deposited on a substrate such as a film or a fabric.

3. The appliqué in accordance with claim 2, wherein the substrate has multiple colours, viewable in-between the flock.

4. The appliqué in accordance with claim 2, wherein the substrate is a polyurethane material.

5. The appliqué in accordance with claim 2, wherein the substrate is a fabric material.

6. The appliqué in accordance with claim 5 wherein the substrate is a non-woven material.

7. The appliqué in accordance with claim 5 wherein the substrate is a textile material with a migration resistant barrier.

8. The appliqué in accordance with claim 6 wherein the non-woven material has a migration resistant barrier.

9. The appliqué in accordance with claim 5, wherein the fabric material is sublimated with a pre-printed pattern.

10. The appliqué in accordance with claim 5, wherein the fabric is a woven fibre.

11. The appliqué in accordance with claim 10 wherein the woven fibre includes a migration resistant barrier.

12. The appliqué in accordance with claim 10, wherein the fibre is a high-lustre fibre.

13. The appliqué in accordance with claims 10, wherein the fibre is one or more of a natural fibre, a synthetic fibre and a combination thereof

14. The appliqué in accordance with claim 2, wherein the substrate is a foil material.

15. The appliqué in accordance with claim 2, wherein the substrate is a film.

16. The appliqué in accordance with claim 15 wherein the film includes a holographic pattern.

17. The appliqué in accordance with claim 14, wherein the foil includes a holographic pattern.

18. The appliqué in accordance with claim 2, wherein the substrate is a migration-resistant barrier.

19. The appliqué in accordance with claim 1, wherein the application adhesive is a hot-melt.

20. A garment or piece of fabric comprising an appliqué in accordance with claim 1.

21. A method of decorating a fabric comprising the steps of applying an appliqué in accordance with claim 1, using the application adhesive.

22. A method of making an appliqué comprising the steps of:
providing an adhesive layer;
applying a flock in a pre-determined pattern; and
retaining the flock with the adhesive layer.

23. The method in accordance with claim 22 including the step of applying the adhesive layer to a film. 24 The method in accordance with claim 22 including the step of applying the adhesive layer to a textile.
